(19) United States
(12) Patent Application Publication
(10) Pub. No.: US 2012/0275189 A1
(43) Pub. Date: Nov. 1, 2012

(54) Patterned Light Distribution Device

(76) Inventors: Jeffrey A. Laine, Tarpon Springs, FL (US); Mark Joseph Bennahmias, Ladera Ranch, CA (US)

(21) Appl. No.: 13/094,324

(22) Filed: Apr. 26, 2011

(51) Int. Cl. F21V 7/22

(52) U.S. Cl. 362/609; 362/611; 362/613

(57) ABSTRACT

A backlight apparatus comprised of a light pipe with one or more light input ends, a top surface, a bottom surface, opposing side, a non imaging optic collimator and scatter inducing elements. The non imaging optic collimator causes the light rays entering into the light pipe to be directed towards the far end relative to the light input end in a specified angular distribution. Pluralities of scatter induced elements (SIE) are introduced in the body of the light pipe between the applicable light input end and the corresponding far end. Individual scatter induced elements may be formed in any geometry, and may be grouped or separated such that there exists a variation of SIE each individually or as grouped, possessing discrete geometries. The light pipe may also vary in the quantity of said SIE at any specified location of the device, and each SIE will have an index of refraction either greater or lesser relative to the index of refraction of the light pipe at the location surrounding the individual scatter induced element. The said SIE cause the light rays to exit the top surface of the device at a specific angular profile and at a specific angular direction with reference to the plane of the light pipe.

### FIELD OF THE INVENTION

The present invention relates generally to a back light such as is used; in back lighting a flat panel liquid crystal display (LCD) and more particularly to a backlight having an optical input arranged to provide a uniform light distribution to the LCD, architectural lighting, general lighting applications, scientific and sample lighting, inspection lighting, photography lighting, etc.

### DESCRIPTION OF THE RELATED ART

Flat panel display such as liquid crystal displays or LCDs used in laptop computers, generally incorporate a back lighting system to illuminate a liquid crystal based display panel. Important requirements of the back lighting system are to provide a substantially uniform light distribution and to provide a sufficiently intense light distribution over the entire plane of the display panel. To accomplish these requirements, the back lighting system typically incorporates a light pipe to couple light energy from a light source to the LCD panel.

Presently back lighting displays include direct-lit backlights, in which multiple lamps, such as CCFLs, or a single serpentine-shaped lamp are arranged behind the display in the field of view of the user, and edge-lit backlights, in which light sources, like light emitting diodes, are placed along one or more edges of a light guide plate located behind the display.

Backlight units of the edge light type are constituted by, besides light source and light pipe, optical members such as prism sheet, light diffusing film, light reflecting film, polarization film, reflection type polarization film, retardation film and electromagnetic wave shielding film and backlight units of the direct type are constituted by, besides light source and light diffusing plate, optical members such as prism sheet, light diffusing film, light reflecting film, polarization film, reflection type polarization film, retardation film and electromagnetic interference shielding film.

Non-scattering back lighting systems offer the advantage that both the light distribution and the angle distribution may be controlled with the use of light bending films located above the light pipe in the direction of the output light. Thus, the light energy may be directed in a way to make more efficient use of the available energy. For example, the light energy may be directed by utilization of additional prisms or film stacks so that substantially all of the light energy is emitted towards the user. Without the use of the prisms or film stacks, as well as reflectors located beneath the bottom surface of the light pipe or directly adhered on the bottom of the light pipe, the output angle of the light emitted from the light pipe would not be directed towards the user and therefore would not be useful in illuminating the LCD. Additionally, the uniformity of the light exiting the light pipe requires does not meet the uniformity requirements of the back lighting system. A diffuser film (or films) is generally employed above the light pipe, within the thin film stack, to address the uniformity problem.

In typical scattering back lighting systems, an array of diffusing elements are disposed along one surface of the light pipe to scatter light rays incident thereto towards an output plane. The output plane is coupled to the LCD panel, coupling the light rays into and through the LCD panel. While a typical scattering back lighting system offers the ability, by controlling the light distribution, it does not offer an ability to control the angle of light distribution. Much of the light energy produced by the back lighting system is wasted because it is scattered in directions that are not useful to a viewer or user of the LCD display. Because much of the light energy is not directed to the user and thus wasted, typical scattering back lighting systems lack the desired light energy intensity or brightness.

A variation of light sources may be utilized in an LCD light pipe such as light emit diodes (LEDs), incandescent bulbs, laser diodes, organic light emitting diodes (OLEDs), and virtually any other point light source. These light sources each typically exhibit some non-uniformity in the light output energy. If left uncorrected, this uniformity will transfer in some manner out of the light pipe. The generally accepted method of correcting this uniformity variation is by placing a light diffuser above the light pipe in the direction of the output rays of the light pipe. Through intelligent positioning of the scattering inducing elements, a uniform output to the light pipe can be achieved.

It is desirable to have this light escape in a prescribed and controlled fashion such that the illumination distribution is uniform down the entire length of the light pipe, meets source brightness requirements, and produces an angular profile which satisfies the display viewing angle requirements. To this end the aforementioned optical members are typically used in practice as standalone films, or combined into a film stack placed on top of the light pipe, to achieve backlight performance requirements but at the expense of increasing the cost of manufacturing.

In addition to the use of specialty optical films, patterns and features, like white dots, prism arrays, and 3D surface relief micro-textures and others for example, are molded directly into both the back side and front side of the light pipe again in an attempt to interrupt the total reflection inside the transparent light pipe media and redirect and scatter the input light coupled from the LEDs as it travels down the length of the light pipe.

Thus there is considerable effort in working towards enhancing the brightness of an edge-lit backlight by better utilization of the available light that is coupled into the body of the light pipe without much loss during transmission.

### SUMMARY OF THE INVENTION

What is needed is a light pipe or backlight apparatus for a backlighting system which eliminates the need of incorporating turning films and angular shaping films after the light exits the light pipe. What is also needed is a light pipe or backlight apparatus for a backlighting system which eliminates the need of incorporating diffuser films after the light exits the light pipe. This said light pipe or backlight apparatus should be conventional in size and do not require larger dimensions that are needed for the LCD display itself. The object of the present invention is to provide a backlight apparatus for an LCD that is approximately or of the same size of a conventional backlight and yet eliminates the need of utilizing a prismatic film(s), angular shaping films and diffuser film(s).

These and other objects and advantages are achieved by the particular backlight construction of the invention. In one embodiment, a backlight apparatus includes a collimating light pipe with a light input end, a top surface, a bottom surface, opposing sides, a far end opposite the light input end, a non imaging optic collimator and scatter inducing elements. The non imaging optic collimator causes the light rays entering into the light pipe to be directed towards the far end relative to the light input end. Pluralities of scatter induced elements are introduced in the body of the light pipe between the light input end and the far end. Individual scatter induced elements may be formed in any geometry, may have a variation of scatter induced elements each possessing discrete geometries within said light pipe, may vary in the quantity of scatter induced elements at any defined location within the light pipe, and each scatter induced element can have an index of refraction either greater or lesser relative to the index of refraction of the light pipe. The said internal scatter induced elements cause the light rays to exit the top surface of the light pipe. Such a construction is different than previous constructions in that the light is directed out of the light pipe through scattering induced elements positioned within the light pipe through the top surface which is adjacent to the liquid crystal display.

### BRIEF DESCRIPTION OF THE DRAWINGS

FIG. 1: illustrates the main PLD concept utilizing NIO optics to specifically shape the light from a source and into the PLD device. The light is then redirected out of the PLD by reflecting the light off of a distribution of custom designed scatter inducing elements.

FIG. 2: illustrates the PLD substrate in the form of a wedge—NOTE: all features in this illustration are at the same height and the PLD substrate is rotated for the top face to be perpendicular to the observer line-of-sight.

FIG. 3: illustrates the optical path if the PLD substrate is in the form of a rectangular volume (included to describe the reduction of light intensity in a controlled fashion from the input side to the opposite end)—NOTE: all features are different heights within the body of the substrate.

FIG. 4: illustrates sample of different possible angular outputs ranging from circular to high aspect elliptical. NOTE: it will be obvious to those familiar with the state-of-the-art that other angular output profiles are also possible with the PLD technology.

FIG. 5: illustrates examples of different possible surface sag profiles for the PLD scattering features .NOTE: it should be obvious to those familiar with the state-of-the-art that other surface profiles are also possible with the PLD technology.

FIG. 6: illustrates different applications of the NIO optics to pseudo-collimate the source, provide a slightly diverging input, a shape of the opposite side that collimates the back reflected light, provide a slightly converging input, and a shape of the opposite side that collimates the back reflected light. NOTE: it should be obvious to those familiar with the state-of-the-art that other NIO coupling schemes are also possible with the PLD technology.

FIG. 7: illustrates different configurations for the PLD features including variable spacing, variable angular orientation, facing the input side, facing the opposite side, variable clear aperture, variable heights, with and without reflective coating—NOTE: it should be obvious to those familiar with the state-of-the-art that other PLD feature geometry are also possible with the PLD technology.

FIG. 8: illustrates an example of a single element biconic NIO for coupling into PLD to form a 30 degree output profile.

FIG. 9: illustrates an example of a dual cylindrical NIO for coupling into PLD to form a 30 degree output profile.

FIG. 10: illustrates and example showing dual torroidal NIO for coupling into PLD to form 30 degree output

### DETAILED DESCRIPTION OF THE PREFERRED EMBODIMENTS

### 1 Overview of Backlight/Apparatus

A backlight apparatus of the present invention transmits light along the length of the device from the light input end or ends. The light is scattered and reflected, by the scatter induced elements located at discrete positions within the device, towards the top emission or output surface. The light then exits the backlight apparatus towards a display, liquid crystal element, or viewer. The backlight provides a substantially uniform light distribution over the display surface of the LCD assembly. By utilizing the construction of the present invention, the light emission profile, symmetric or asymmetric, and the light emission output angle relative to the output surface can be selected.

The present invention and various features and advantageous details thereof are explained more fully with reference to the nonlimiting embodiments described in detail below.

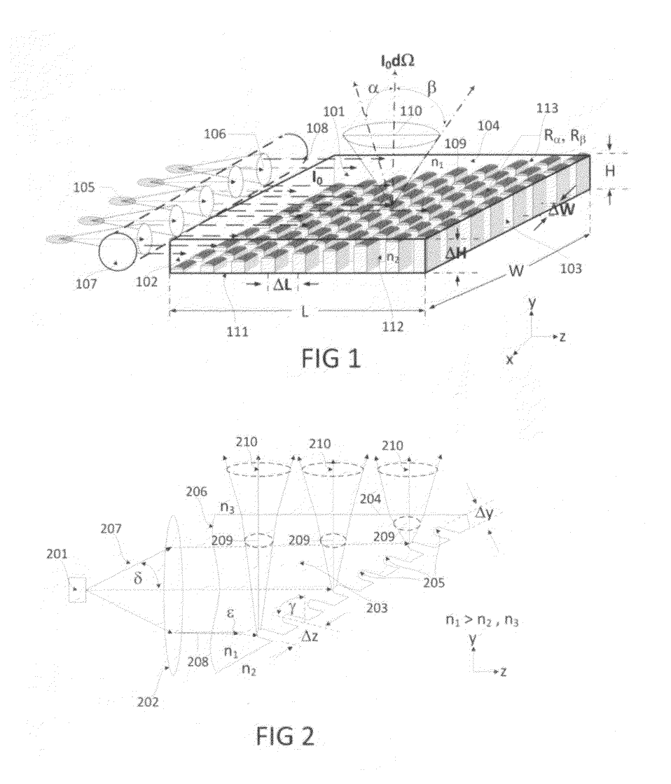

Referring no to FIG. 1 illustrates a backlight apparatus having a source 105, with an emission profile 106 that can be either circular or elliptical incident on a NIE 107 which generates a preferred output light geometry 108 which in turn is launched into a Pattern Light Distribution Device, PLD, 101. A plurality of SIE 109 redirect the light through the top surface 104 into a prescribed angular output profile 110 relative to the top surface of the device. The PLD 101 has a light input end 102, opposing side 103 which is opposite the light input end, top surface 104, bottom surface 111 and opposing sides 112, 113. A light source assembly, consisting of a light emitting device, such as an LED, laser diode, fiber optic cable or conventional bulb 105 is emitted to a Non Imaging Optic 106 which is then emitted to the input surface of the PLD 102.

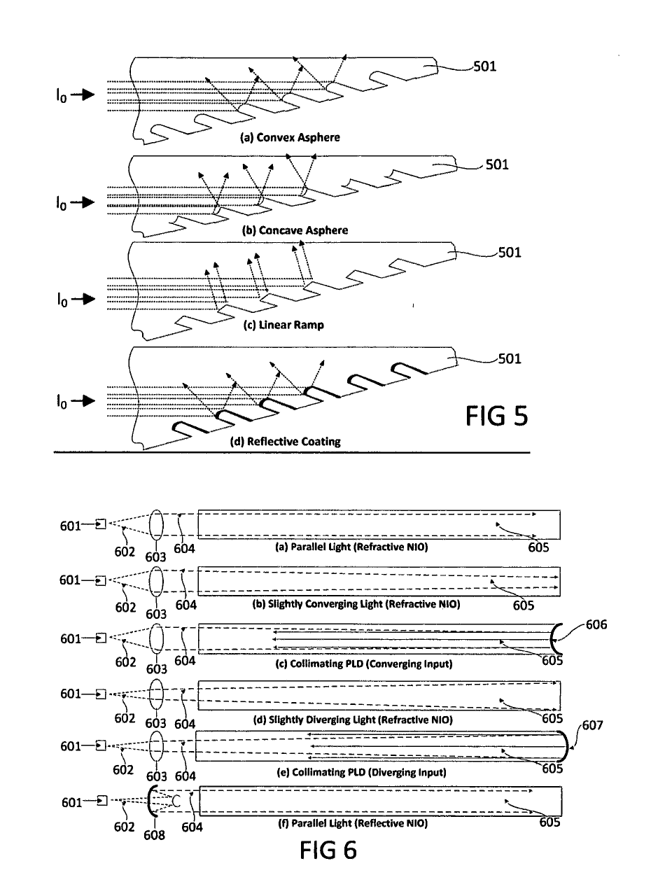

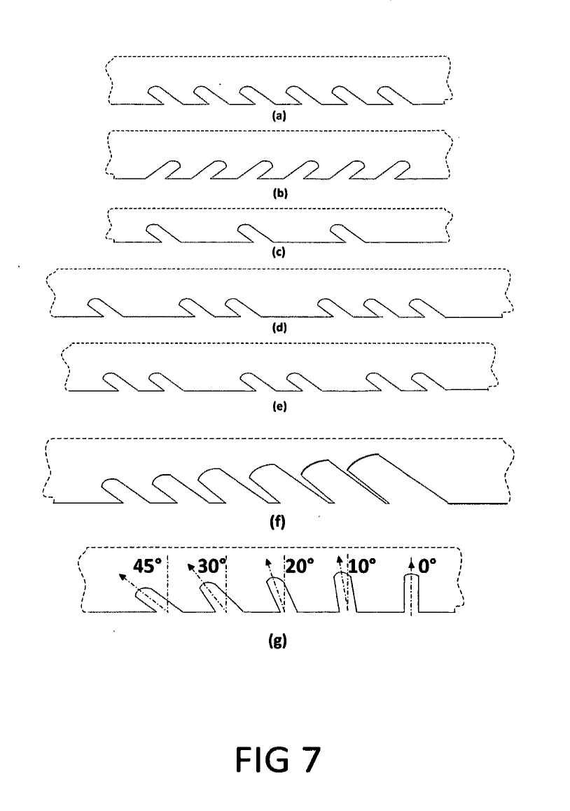

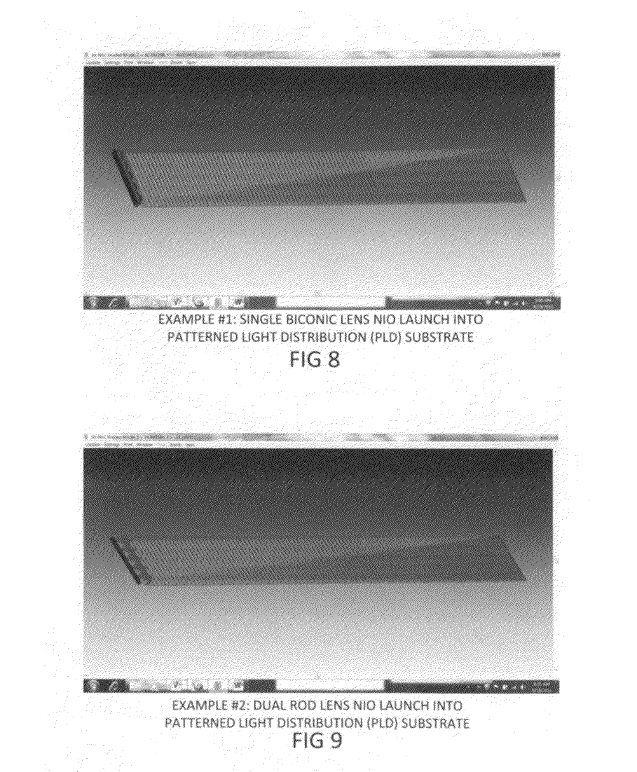

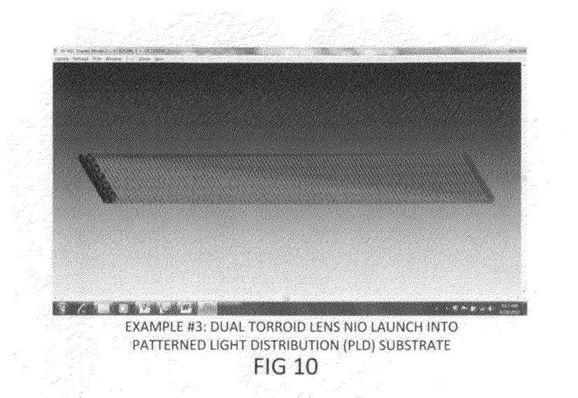

Pursuant to the present invention, the Patterned Light Distribution Device, PLD 101 may include other configurations and components combined therewith without departing from the spirit or scope of the present invention. For example, FIG. 6 illustrates that the Non Imaging Optic can be designed for a variety of output emission profiles. In some configurations, the Non Imaging Optic can be omitted from the assembly. FIG. 4 illustrates a limited selection of representative examples of possible output profiles for the device. Although certain preferred embodiments and examples are disclosed below, it will be understood by those in the art that the invention extends beyond the specifically disclosed embodiments and/or uses of the invention and obvious modifications and equivalents thereof. Thus, it is intended that the scope of the invention herein disclosed should not be limited by the particular disclosed embodiments described below.

FIG. 5 illustrates an enlarged view of a portion of the PLD 101 including the bottom surface 111. As will be described in greater detail below, the bottom surface 111 includes a plurality of scatter induced elements 109. The scatter induced elements 109 in each embodiment are angled upward towards the top surface 104. As discussed below, the scatter induced elements can possess a large variety of surface profiles without departing from the scope of the present invention.

### A. Illumination Sources

The particular type of light source 105 may vary considerably without departing from the scope of the invention. For example, an LED, OLED, laser diode, incandescent bulb, fiber optic cable or any other such point source may be utilized. Additionally an extended source, as defined a larger than a point source may be utilized. For example, a light bar, emitting wave guide, neon tube, and CCFL tube may be utilized. The invention is not limited to any particular source of light.

### B. Non Imaging Optic

The optimum design for the non imaging optics 106 is very characteristic of the intended light source and desired output emission profile of the PLD. FIG. 6 illustrates a variety of intended emission patterns specific to an application and light source.

### 2 Device Scatter Induced Elements

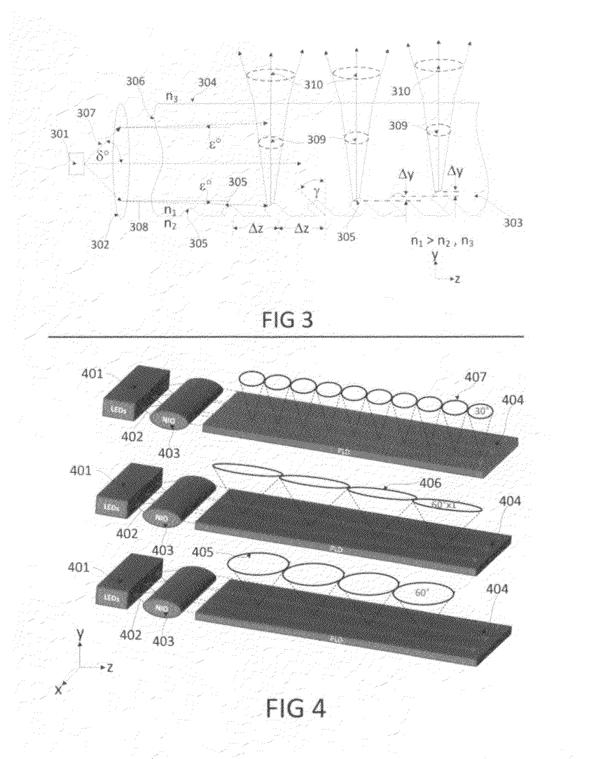

A general discussion of the distribution and shape of scattering induced elements follows. Referring to FIG. 1, a device is illustrated having a plurality of scatter induced elements 109 wherein the scatter induced elements will have either linear or variable spacing in the ΔL. Moreover the scatter induced elements will have either linear or variable spacing in ΔW and in depth ΔH, as measured from the bottom face 111, as the light propagates from the light input side to the opposite side. It should be noted that the scatter induced elements 109 do not need to be laterally or longitudinally continuous and any individual output emission pattern can be separately designed. FIG. 2 illustrates the PLD in the form of a wedge. 209 and 210 are the generated angular profiles formed within the PLD and illustrated after exiting the top surface of the PLD. The generated angular profile described, and shown in FIG. 1, 110 with axis α and β, is generated by a particular scatter induced element within the PLD respectively. The source 201 emits light 207 at angle δ towards the non imaging optic 202 which shapes the light into an optimum configuration for injection into the PLD. The input angle to the PLD, for this example, is pseudo collimated to within ε. FIG. 3 illustrates the optical path of the PLD in the form of a rectangular volume wherein the position along the H axis as shown in FIG. 1 of each subsequent line of scattering inducing elements varies in a prescribed fashion. FIG 5 illustrates examples of different possible surface sag profiles for the PLD scattering features. It should be obvious to those familiar with the state-of-the-art that other surface profiles are also possible with the PLD technology. Total length of the device is L. ΔL is the spacing between scatter induced element centers along the length of the device. The thickness of the device is H where ΔH is the height of a particular scatter induced device. The width of the device is W where ΔW is the spacing between scatter induced elements. The invention is not limited to any particular PLD geometry in height, width or length.

### 3 Fabrication of Device

### A Patterned Light Distribution Device, PLD

Conveniently, the PLD of the present invention can be carried our using any fabrication method. For manufacturing operation, it is moreover an advantage to employ a replication/lamination method.

Surface induced scatter elements can be cut when fabricating the insert or master for replicating the PLD provided there is no undercutting. Any undercutting inhibits the mold release. There is a general degradation as you move from any master/insert to the submaster to a finished part. Degradation changes the geometry of the scatter induced elements. Much of this degradation is due to forces exerted during release. Thus the shape of the master/insert is not necessarily the finished scatter induced element structure.

To fabricate a master for the above discussed device, a metal master can be machined or diamond turned. A spherical or aspheric curve can be cut on a diamond and the resulting curved optical microelement could be as small as 25 microns. Diamond tooling wears out so it is advantageous to fabricate one master and then replicate a series of submasters.

### B Non Imaging Optics, NIO

Conveniently, the NIO utilized in the present invention can be carried our using any fabrication method. For manufacturing operation, it is moreover an advantage to employ either a replication or conventional polishing method.

Non-imaging optical elements can be figured when fabricating an insert or master for replication. There is a general degradation as you move from any master/insert to the submaster to a finished part. Degradation changes the geometry of the non-imaging optical elements. Much of this degradation is due to forces exerted during release. Thus the shape of the master/insert is not necessarily the finished non-imaging optics figure.

Conventional grinding and polishing is an alternative method for fabrication of the non-imaging optic elements. For systems requiring multiple element NIO, the availability of many glass varieties makes conventional manufacturing methods advantageous.

The present invention described herein provides substantially improved results that are unexpected in that a very precise light output intensity angular distribution can be obtained. Additionally the light output angle relative to the normal of the output surface of the PLD can be designated and obtained. The present invention described herein can be practiced without undue experimentation. The entirety of everything cited above or below is hereby expressly incorporated by reference.

Although the best mode contemplated by the inventors of carrying out the present invention is disclosed above, practice of the present invention is not limited thereto. It will be manifest that various additions, modifications and rearrangements of the features of the present invention may be made without deviation from the spirit and scope of the underlying inventive concept.

For example, the compactness of the system could be enhanced by providing thinner illumination sources or thinner PLD devices. Similarly, although plastic is preferred for the PLD, any optically transparent material could be used in its place. In addition, the rest of the individual components need not be fabricated from the disclosed materials, but fabricated from virtually any suitable material.

Moreover, the individual components need not be formed in the disclosed shapes, or assembled in the disclosed configurations, but could be provided in virtually any shape, and assembled in virtually any configuration, which emit light into a prescribed geometric intensity. Further, although the liquid crystal display mentioned herein is a physically separate module, it will be manifest that the liquid crystal display may be integrated into the apparatus with which it is associated. Furthermore, all the disclosed features of each disclosed embodiment can be combined with, or substituted for, the disclosed features of every other disclosed embodiment except where such features are mutually exclusive.

What is claimed is:

1. A backlight apparatus comprising:
a device having a light input end, a top surface, a bottom surface opposite the top surface opposing sides, a far end opposite the light input end;
a non imaging optic located near the light source used to transfer the input light throughout the interior of the light pipe in a controlled manner;
a plurality of scatter inducing elements disposed within the device between the non imaging optic collimator and the far end;
scatter induced elements composed of individually defined geometries whose purpose is to direct the light out of the top surface of the light pipe in particular angular distributions and at a particular output angle with reference to the normal of the top surface; the top and bottom surfaces of said light pipe may or may not be parallel to each other

2. The backlight apparatus according to claim 1 wherein a non-imaging optic located near the light source produces either a divergent or convergent beam which is used to transfer light throughout the interior of the light pipe in a controlled manner.

3. The backlight apparatus according to claim 1 wherein there is a plurality of sources located on one or more sides of the light pipe.

4. The backlight apparatus according to claim 1 wherein there is a plurality of non-imaging optic located near the light sources produces either a divergent or convergent beam which is used to transfer light throughout the interior of the light pipe in a controlled manner.

5. The backlight apparatus according to claim 1 wherein the source requires no non-imaging optic.

6. The backlight apparatus according to claim 1 wherein the NIO is comprised of one or more refractive, reflective, diffractive or any combination of the aforementioned optical elements.

7. The backlight apparatus according to claim 1 wherein the light input surface is perpendicular to the optic axis as defined by the light source.

8. The backlight apparatus according to claim 1 wherein the light input surface is at an angle to the optic axis as defined by the light source.

9. The backlight apparatus according to claim 1 wherein the light input surface is comprised of a plurality of facets.

10. The backlight apparatus according to claim 1 wherein the light input surface is comprised of a curved surface.

11. The backlight apparatus according to claim 1 wherein there is a plurality of light input surfaces located on of the light pipe.

12. The backlight apparatus according to claim 1 wherein the density of SIE vary across the light pipe.

13. The backlight apparatus according to claim 1 wherein the distance between adjacent SIE are constant across a light pipe in at least one direction. In FIG. 1, the separation is shown as ΔH, ΔL and ΔW and the direction is shown as H, L and W .

14. The backlight apparatus according to claim 1 wherein the distance between adjacent SIE are not constant across a light pipe in at least one direction. In FIG. 1, the separation is shown as ΔH, ΔL and ΔW and the direction is shown as H, L and W .

15. The backlight apparatus according to claim 1 wherein the SIE have a constant geometry.

16. The backlight apparatus according to claim 1 wherein the SIE have more than a single geometry.

17. The backlight apparatus according to claim 1 wherein the SIE each have a varying angular orientation relative to the light input surface.

18. The backlight apparatus according to claim 1 wherein the index of refraction at least one axis of the SIE is different from the backlight substrate in the corresponding axis.

19. The backlight apparatus according to claim 1 wherein a reflective coating is applied to the scatter induced elements

20.

21. The backlight apparatus according to claim 1 wherein the critical surface of the SIE is a convex asphere

22. The backlight apparatus according to claim 1 wherein the critical surface of SIE is a concave asphere

23. The backlight apparatus according to claim 1 wherein the critical surface of the SIE is a linear ramp

24. The backlight apparatus according to claim 1 wherein the critical surface of the SIE is biconic

25. The backlight apparatus according to claim 1 wherein the critical surface of the SIE is a torroid

26. The backlight apparatus according to claim 1 wherein a reflector is located below the bottom surface of the light pipe.

27. The backlight apparatus according to claim 1 wherein a reflective coating is applied to the bottom surface of the light pipe.

28. The backlight apparatus according to claim 1 wherein a reflector is located on the opposite side relative to the source.

29. The backlight apparatus according to claim 1 wherein the reflector located on the opposite side relative to the source is perpendicular to the optic axis as defined by the light source.

30. The backlight apparatus according to claim 1 wherein the light input surface is at an angle to the optic axis as defined by the light source.

31. The backlight apparatus according to claim 1 wherein the reflector located on the opposite side relative to the source is comprised of a plurality of facets.

32. The backlight apparatus according to claim 1 wherein the reflector located on the opposite side relative to the source is comprised of a curved surface.
